(19) United States
(12) Patent Application Publication
(10) Pub. No.: US 2010/0161146 A1
(43) Pub. Date: Jun. 24, 2010

(54) VARIABLE ENERGY PRICING IN SHORTAGE CONDITIONS

(75) Inventors: Gregory J. Boss, Saginaw, MI (US); James R. Doran, New Milford, CT (US); Rick A. Hamilton, II, Charlotesville, VA (US); Anne R. Sand, Peyton, CO (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/342,428

(22) Filed: Dec. 23, 2008

(51) Int. Cl. G05B 15/00

(52) U.S. Cl. 700/291

(57) ABSTRACT

This disclosure enables energy providers and users to establish variable pricing or maximum thresholds for individual components (aka appliances) or groups of components. The consumer (individual or business) defines a usage policy for each device or component which defines limits the consumer is willing to pay in a supply shortage. The usage policy also defines safety parameters as well as energy limiting capabilities of the appliance or component. Energy suppliers use this usage policy to determine which devices get managed or powered off in a shortage situation. With the detailed consumer supply and demand data available from this invention, energy providers may use economic analysis to better understand customer price sensitivity. This information will enable the provider to run simulations of different energy shortage scenarios.

### CROSS-REFERENCE TO RELATED APPLICATIONS

The present application is related in some aspects to commonly owned and co-pending application entitled “Framework for Managing Consumption of Energy”, assigned attorney docket no. END920070426US1, which was filed on Nov. 22, 2008, and was assigned application Ser. No. 4/338,540, the entire contents of which are hereby incorporated by reference. The present application is also related in some aspects to commonly owned and co-pending application entitled “Policy-Based Energy Management”, assigned attorney docket no. END920070427US1, which was filed on Nov. 22, 2008, and was assigned application Ser. No. 4/338,548, the entire contents of which are hereby incorporated by reference.

### FIELD OF THE INVENTION

This invention includes methods for providing variable energy pricing for objects (e.g., devices) of a system in shortage conditions. This responds to customer price sensitivity by considering the maximum threshold a consumer will bid for energy to a given device during a situation when less than adequate supply exists for demand.

### BACKGROUND OF THE INVENTION

Currently consumers are charged the same rate for their energy usage, irrespective if they conserve or not, if there is a shortage or not, etc. Current energy systems are very limited in their ability to handle shortage situations. Given the threat of terrorist attacks, natural disasters, brownouts, blackouts and supply/demand imbalances, better systems are needed. Consumers give very little thought to non-critical devices or groups of devices that could be powered down or managed if needed.

### SUMMARY OF THE INVENTION

In general, this disclosure enables energy providers and users to establish variable pricing or maximum thresholds for individual components (aka appliances) or groups of components. The consumer (individual or business) defines a usage policy for each device or component which defines limits the consumer is willing to pay in a supply shortage. The usage policy also defines safety parameters as well as energy limiting capabilities of the appliance or component. Energy suppliers use this usage policy to determine which devices get managed or powered off in a shortage situation. With the detailed consumer supply and demand data available from this invention, energy providers may use economic analysis to better understand customer price sensitivity. This information will enable the provider to run simulations of different energy shortage scenarios.

A first aspect of the present invention provides a method for variable energy pricing, comprising: detecting an energy shortage; accessing a set of usage policies for a set of objects, the set of usage policies comprising listings and grouping of the set of objects, and price sensitivities for the set of objects; and managing optimization of energy consumption of the set of objects based on the price sensitivities policy priority, and a severity of the energy shortage.

A second aspect of the present invention provides a system for variable energy pricing, comprising: a system for variable energy pricing, comprising: a module for detecting an energy shortage; a module for accessing a set of usage policies for a set of objects, the set of usage policies comprising listings and grouping of the set of objects, and price sensitivities for the set of objects; and a module for managing optimization of energy consumption of the set of objects based on the price sensitivities policy priority, and a severity of the energy shortage.

A third aspect of the present invention provides a method for variable energy pricing, comprising: computer readable medium containing a program product for variable energy pricing, the computer readable medium comprising program code for causing a computer system to: detect an energy shortage; access a set of usage policies for a set of objects, the set of usage policies comprising listings and grouping of the set of objects, and price sensitivities for the set of objects; and manage optimization of energy consumption of the set of objects based on the price sensitivities policy priority, and a severity of the energy shortage.

A fourth aspect of the present invention provides a method for deploying a system for variable energy pricing, comprising: deploying a computer infrastructure being operable to: detect an energy shortage; access a set of usage policies for a set of objects, the set of usage policies comprising listings and grouping of the set of objects, and price sensitivities for the set of objects; and manage optimization of energy consumption of the set of objects based on the price sensitivities policy priority, and a severity of the energy shortage.

A fifth aspect of the present invention provides a computer-implemented method for variable energy pricing, comprising: detecting an energy shortage; accessing a set of usage policies for a set of objects, the set of usage policies comprising listings and grouping of the set of objects, and price sensitivities for the set of objects; and managing optimization of energy consumption of the set of objects based on the price sensitivities policy priority, and a severity of the energy shortage.

A sixth aspect of the present invention provides a data processing system for variable energy pricing, comprising: a memory medium comprising instructions; a bus coupled to the memory medium; and a processor coupled to the bus that when executing the instructions causes the data processing system to:

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative energy management hierarchy according to the present invention.

FIG. 2 depicts an interface to heterogeneous objects according to the present invention.

FIG. 3 depicts a more specific computerized implementation according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

As used herein, the following terms have the associated meanings:

“Set”—a quantity of at least one.

“Object”—any device, group of devices, or organization using devices that consume energy.

As indicated above, this disclosure enables energy providers and users to establish variable pricing or maximum thresholds for individual components (aka appliances) or groups of components. The consumer (individual or business) defines a usage policy for each device or component which defines limits the consumer is willing to pay in a supply shortage. The usage policy also defines safety parameters as well as energy limiting capabilities of the appliance or component. Energy suppliers use this usage policy to determine which devices get managed or powered off in a shortage situation. With the detailed consumer supply and demand data available from this invention, energy providers may use economic analysis to better understand customer price sensitivity. This information will enable the provider to run simulations of different energy shortage scenarios.

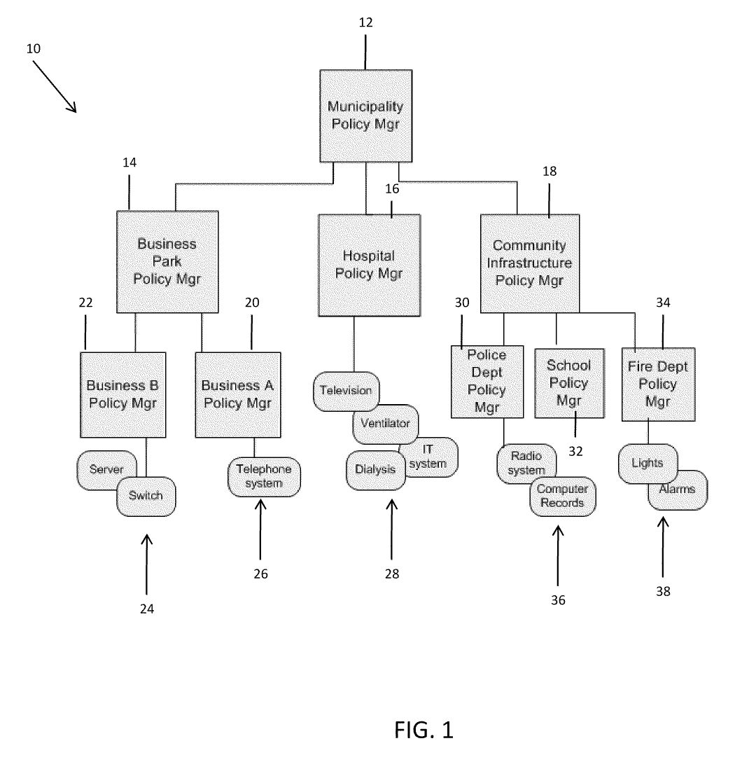

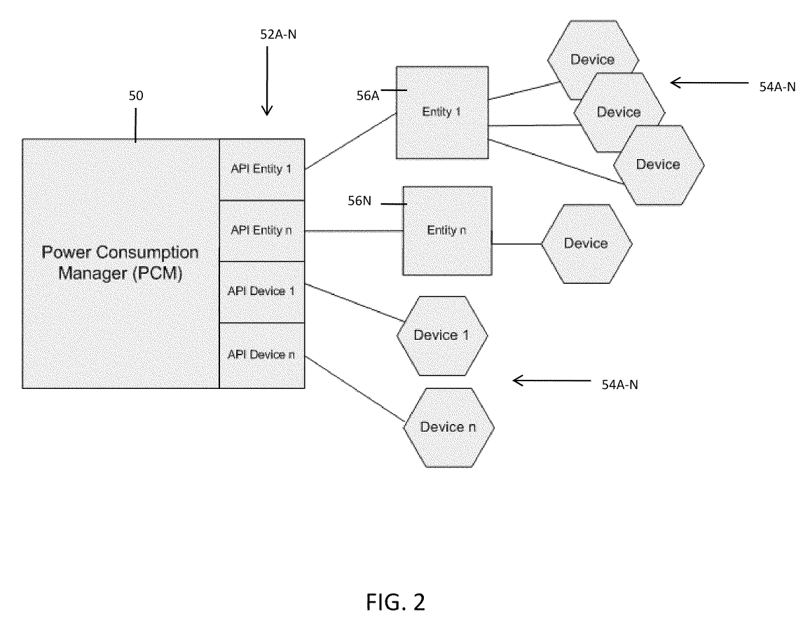

This technology can leverage the framework hierarchy, energy control manager, policy control manager, GUI, as described in the above-incorporated patent applications. For clarity, corresponding description of some of such elements is given in conjunction with FIGS. 1-2. Referring now to FIG. 1 a framework hierarchy 10 is shown. FIG. 1 is to demonstrate, among other things, that the present invention could be implemented in conjunction with any hierarchy of devices, regardless of complexity. In the example shown, energy control management systems/energy control manager (hereinafter PCM) are utilized on multiple levels. Municipality PCM 12 works in conjunction with business park PCM 14, hospital PCM 16, and community infrastructure PCM 18. Further, business park PCM 14 interacts with business A PCM 20 and business B PCM 22, each of which controls energy consumption with their own devices 24 and 26. Similarly, hospital PCM 16 controls energy consumption by devices 28. Community infrastructure PCM 18 is shown interacting with police department PCM 30, school PCM 32, and fire department PCM 34, which among themselves, manage devices 36 and 38. As can be seen, a PCM under the present invention can not only interact with devices, but also with other PCMs.

Referring now to FIG. 2, the functions of a PCM 50 will be described. As used in FIG. 2, entities 56A-n represents any business object that has one or more component/device. Sample entities may include a hospital, business or municipality. As such, devices 54A-N are each a piece of the overall system who's energy may be modulated. This may be a particular software application, piece of IT hardware (server, storage, networking switch, etc. . . . ), other hardware (life support equipment, refrigerator, etc.).

Under the present invention, each device, entity, etc. is enrolled into the system. This may occur manually, through auto-discovery by PCM 50 or by device 54A-N self-enrollment to PCM 50. Once enrolled, PCM 50 maintains a database of devices and their meta data. Sample device meta data are as follows:

Device ID=0487

Device name=“refrigerator01”

Average energy consumed=50

Modulate capabilities=“on/off”

Quiesce first=“no”

Regardless, this functionality may be implemented with a single energy management server, groups of servers, or a hierarchy of servers. A hierarchy is the preferred embodiment for an enterprise system, as that allows for delegation to sub-entities.

As further depicted, PCM 50 has a set of application programming interfaces (APIs) 52A-N which allow communication to occur between PCM 50 and devices 54A-N and/or entities 56A-N. Although not shown in FIG. 2, an API would also allow PCM 50 to interface with another PCM. Heterogeneous devices from different vendors may have very different interfaces. The technology described herein will interface to different devices, or to any known or future energy management standard. For example, the interface to communicate with IBM WebSphere XD software (WebSphere is a trademark of IBM Corp in the United States and/or other countries) may differ greatly from the interface for a medical device to manage energy to an anesthesia machine, which would differ from the interface to a refrigerator.

Under the present invention, customers preregister with the energy provider, including the following information: listing and groupings of devices; price sensitivity for each, communicated as either a maximum threshold or variable price per device(s); energy limiting capabilities and methods for each; and indicators for devices that are critical to safety or medical necessity. When an energy shortage situation occurs, the system enables consumers to request a real-time modification of their management policy to change their price sensitivity. The energy provider can then manage (e.g., throttle) energy to consumers based on preset policy and severity of shortage. Then, consumers are billed based on energy used and agreed to price based on device usage.

Any known or future methods for physically controlling energy to devices or monitoring their energy usage may be used.

### Setting Policy per Device, Component or System

In situations where energy may be managed to components of a system that do not map directly to a physical device, thresholds may be set per component or system that enables the component. One example of this situation may be to set a maximum threshold for a noncritical application system running on a server, and another threshold for a critical application. If the noncritical application uses a particular storage device, the energy to the associated storage device may share the same maximum threshold or energy pricing as other components of the application system (e.g., server, database, load balancer, etc.). Thus, the present design allows for energy management using multiple techniques. Examples are: maximum price threshold set per device or groups of devices; and/or variable pricing per device or groups of devices.

### A. Maximum Price Threshold Set per Device or Groups of Devices

Maximum thresholds may be expressed as an absolute value (e.g. $/kW) or relative value (e.g. % increase in $/kW over previous or average cost).

### Home Scenario

Table 1 below shows a home scenario that uses relative values to set the maximum thresholds. The user has set the threshold to be a percentage above the average energy price. If a shortage situation occurs, the following policies will be initiated:

Television: If energy prices increase 20%, energy to the television will be managed. Since the only throttling capabilities the television has are on/off, the energy will be turned off when the threshold is exceeded.

Refrigerator: If the price increases by over 45%, the refrigerator will be turned off.

Heater: If the price increases by over 15%, the high setting on the heater will be disabled and only low will be allowed. If prices increase above 30%, the heater low setting threshold will be reached and that setting will now be disabled, removing energy to the heater altogether.

Medical device: In the case of a critical medical device, the customer may not want energy managed at any cost.

TABLE I
Home Scenario

| | | Maximum threshold |
|---|---|---|
| | Manage | (% increase in $/kW |
| Device | capabilities | from average) |
| Television | On/Off | 20% above |
| Refrigerator | On/Off | 45% above |
| Heater | High/Low/Off | High = 15%, Low = $30% |
| Medical | On/Off | unlimited |
| device | | |

### Retail Business Scenario

Table 2 below illustrates a retail business scenario that uses absolute values to set maximum manage thresholds. In this case, energy is usually $0.12 per kilowatt. During peak business hours of Monday-Friday 9:00 am to 6:00 PM, the following policy will be in place:

Lights: The overhead lights operate with a continuous control dimmer. They are fully lit until a price of $0.45 per kW. After that, for every $0.05 increase per kilowatt, the lights will be dimmed 10% of their full energy. In this case, at $0.95/kW the lights will be dimmed down to zero percent, meaning they will be completely off.

Display signs: The display signs will be turned off when price exceeds $0.30/kW.

Heater: If the price exceeds $0.20, the high setting on the heater will be disabled and only low will be allowed. If the price exceeds $0.40, the heater low setting threshold will be reached and that setting will now be disabled, removing energy to the heater altogether.

TABLE II
Retail Business Scenario

| | | Maximum threshold ($/kW) | |
|---|---|---|---|
| | Manage | Monday-Friday | |
| Device | capabilities | 9:00 am-6:00 pm | Off Business Hours |
| Lights | On/Off/Continuous | $0.45 for full on. Dim | $0.20 for full on. Dim |
| | dimmer | 10% for each $.05 above | 10% for each $.05 above |
| | | $.15 | $.15 |
| Display signs | On/Off | $0.30 | $0.20 |
| Heat | High/Low/Off | High = $.20, Low = $.40 | High = $.18, Low = $.30 |

### B. Variable Pricing per Device or Groups of Devices

Another method is disclosed for enabling energy providers to use price sensitivity to incent customers to conserve during a shortage. This method would be especially useful in cases where devices are critical (medical necessity, safety, etc.) or noncritical (entertainment, leisure, etc.). Energy providers may want to offer lower prices for critical devices but charge customers more for noncritical devices during a shortage.

### Home Scenario

Table 3 below shows a home scenario that uses absolute values to set a variable price to be charged per device. If a shortage situation occurs, the following policies will be initiated:

Television: Energy consumed by the television will be charged at $0.18 per kW during the shortage window.

Refrigerator: Energy consumed by the refrigerator will be charged at $0.33 per kW.

Heater: If the high setting on the heater is used, energy consumed will be charged at $0.30 per kW. If the low setting is used, energy will be charged at $0.37 per kW.

Medical device: Energy provider may allow a policy for the price to be a low $0.05 per kW for a critical medical device.

TABLE III
Home Scenario

| | Manage | Price to be paid per kW |
|---|---|---|
| Device | capabilities | per device |
| Television | On/Off | $0.18 |
| Refrigerator | On/Off | $0.33 |
| Heater | High/Low/Off | High = $.30, Low = $.37 |
| Medical | On/Off | $0.05 |
| device | | |

### Supply and Demand Calculations, Simulations and Predictions

The data enabled by this invention may be very valuable to providers. They would have detailed information about the price sensitivity of their customers, down to the detailed level of each device. With the policy data, energy providers may use basic microeconomic supply and demand methods to track, chart and predict consumer behavior in shortage situations. Knowing the current pricing or thresholds that consumers have agreed to, and tracking their behavior in past shortages, providers may run simulations to predict energy usage for different shortage scenarios.

Providers may also use this data to consider future programs or incentives that could encourage users to conserve energy.

### II. Computerized Implementation

Referring now to FIG. 4, a computerized implementation 100 of the present invention is shown. As depicted, implementation 100 includes computer system/PCM 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

Computer system is intended to represent any type of computer system that may be implemented in deploying/realizing the teachings recited herein. In this particular example, computer system 104 represents an illustrative system that could represent a PCM. It should be understood that any other computers implemented under the present invention will have similar components, but may perform different functions/have different software. As shown, computer system 104 includes a processing unit 106, a memory 108, a bus 110, and device interfaces 112. Further, computer system 104 is shown communicating with one or more external devices 114 that communicate with bus via device interfaces. In general, processing unit 106 executes computer program code, such variable pricing program 124, which is stored in memory 108 and/or storage system 116. While executing computer program code, processing unit 106 can read and/or write data to/from memory 108, storage system 116, and/or device interfaces 112. Bus 110 provides a communication link between each of the components in computer system 104. Although not shown, computer system 104 could also include I/O interfaces that communicate with: one or more external devices such as a kiosk, a checkout station, a keyboard, a pointing device, a display, etc.); one or more devices that enable a user to interact with computer system 104; and/or any devices (e.g., network card, modem, etc.) that enable computer system 104 to communicate with one or more other computing devices. Although not shown, computer system 104 could contain multiple processing units.

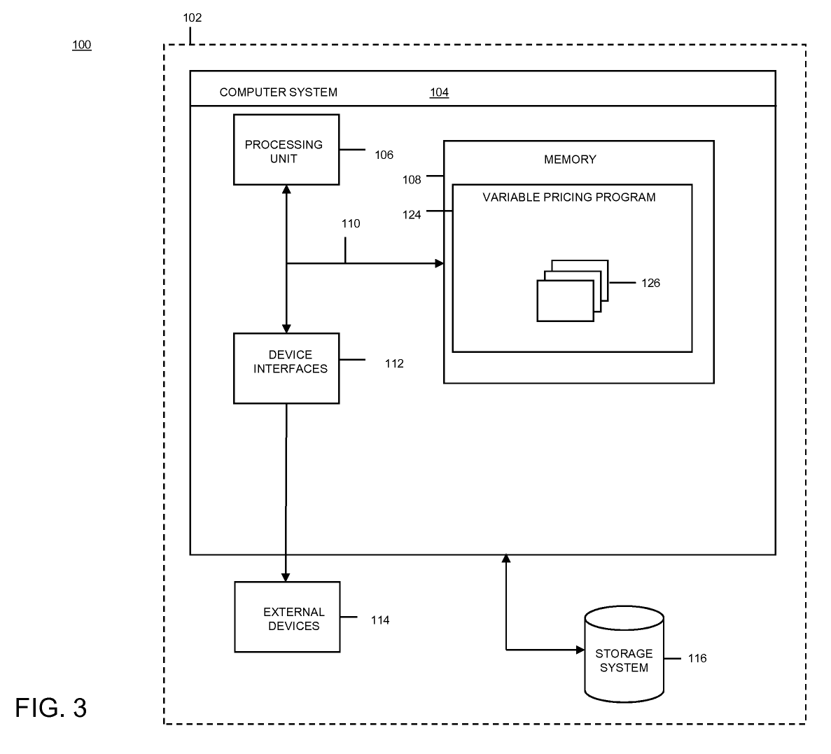

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various processes of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, device interfaces 112 can comprise any module for exchanging information with one or more external devices. Still further, it is understood that one or more additional components (e.g., system software, math co-processing unit, etc.) not shown in FIG. 3 can be included in computer system 104.

Storage system 116 can be any type of system (e.g., storage units 70A-N of FIG. 3) capable of providing storage for information under the present invention. To this extent, storage system 116 could include one or more storage devices such as magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104.

Shown in memory 108 of computer system 104 is variable pricing program 124, which has a set of modules 126. Set of modules 126 generally provide the functions of the present invention as described herein. For example, (among other things), set of modules 26 is configured to: detect an energy shortage; access a set of usage policies for a set of objects, the set of usage policies comprising listings and grouping of the set of objects, and price sensitivities for the set of objects; manage optimization of energy consumption of the set of objects based on the price sensitivities policy priority, and a severity of the energy shortage. In addition, variable pricing program can accommodate: customer preregistrations; price sensitivities comprising maximum price thresholds per object or group of objects; price sensitivities comprising variable pricing settings per object or group of objects, etc.

While shown and described herein as a framework for variable energy pricing, it is understood that the invention further provides various alternative embodiments. For example, in one embodiment, the invention provides a computer-readable/useable medium that includes computer program code to enable a computer infrastructure to variable energy pricing. To this extent, the computer-readable/useable medium contains program code that implements each of the various processes of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 3) and/or storage system 116 (FIG. 3) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to provide variable energy pricing. In this case, the service provider can create, maintain, support, etc., a computer infrastructure, such as computer infrastructure 102 (FIG. 3) that performs the process of the invention for one or more customers. In return, the service provider can receive payment from the customers under a subscription and/or fee agreement and/or the service provider can receive payment from the sale of advertising content to one or more third parties.

In still another embodiment, the invention provides a computer-implemented method for variable energy pricing. In this case, a computer infrastructure, such as computer infrastructure 102 (FIG. 3), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 104 (FIG. 3), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for variable energy pricing, comprising:
detecting an energy shortage;
accessing a set of usage policies for a set of objects, the set of usage policies comprising listings and grouping of the set of objects, and price sensitivities for the set of objects; and
managing optimization of energy consumption of the set of objects based on the price sensitivities policy priority, and a severity of the energy shortage.

2. The method of claim 1, the set of usage policies further comprising:
energy limiting capabilities for the set of devices; and
an indication for any of the set of objects that is determined to be critical.

3. The method of claim 1, the set of usage policies being received pursuant to registration of the set of objects.

4. The method of claim 1, the price sensitivities comprising maximum price thresholds per object or group of objects.

5. The method of claim 1, the price sensitivities comprising variable pricing settings per object or group of objects.

6. The method of claim 1, the set of policies being updatable in real-time.

7. A system for variable energy pricing, comprising:
a module for detecting an energy shortage;
a module for accessing a set of usage policies for a set of objects, the set of usage policies comprising listings and grouping of the set of objects, and price sensitivities for the set of objects; and
a module for managing optimization of energy consumption of the set of objects based on the price sensitivities policy priority, and a severity of the energy shortage.

8. The system of claim 7, the set of usage policies further comprising:
energy limiting capabilities for the set of devices; and
indication for any of the set of objects that is determined to be critical.

9. The system of claim 7, the set of usage policies being received pursuant to registration of the set of objects.

10. The system of claim 7, the price sensitivities comprising maximum price thresholds per object or group of objects.

11. The system of claim 7, the price sensitivities comprising variable pricing settings per object or group of objects.

12. The system of claim 7, the set of policies being updatable in real-time.

13. A computer readable medium containing a program product for variable energy pricing, the computer readable medium comprising program code for causing a computer system to:
detect an energy shortage;
access a set of usage policies for a set of objects, the set of usage policies comprising listings and grouping of the set of objects, and price sensitivities for the set of objects; and
manage optimization of energy consumption of the set of objects based on the price sensitivities policy priority, and a severity of the energy shortage.

14. The computer readable medium containing the program product of claim 13, the set of usage policies further comprising:
energy limiting capabilities for the set of devices; and
an indication for any of the set of objects that is determined to be critical.

15. The computer readable medium containing the program product of claim 13, the set of usage policies being received pursuant to registration of the set of objects.

16. The computer readable medium containing the program product of claim 13, the price sensitivities comprising maximum price thresholds per object or group of objects.

17. The computer readable medium containing the program product of claim 13, the price sensitivities comprising variable pricing settings per object or group of objects.

18. The computer readable medium containing the program product of claim 13, the set of policies being updatable in real-time.

19. A method for deploying a system for variable energy pricing, comprising:
deploying a computer infrastructure being operable to:
detect an energy shortage;
access a set of usage policies for a set of objects, the set of usage policies comprising listings and grouping of the set of objects, and price sensitivities for the set of objects; and
manage optimization of energy consumption of the set of objects based on the price sensitivities policy priority, and a severity of the energy shortage.

20. The method of claim 1, the set of usage policies further comprising:
energy limiting capabilities for the set of devices; and
an indication for any of the set of objects that is determined to be critical.
